(19) United States
(12) Patent Application Publication
(10) Pub. No.: US 2023/0397319 A1
(43) Pub. Date: Dec. 7, 2023

(54) CONTROLLER FOR LED LAMP STRING AND CONTROL SYSTEM

(71) Applicant: MING LI, SHULAN (CN)

(72) Inventor: MING LI, SHULAN (CN)

(21) Appl. No.: 17/804,852

(22) Filed: Jun. 1, 2022

(51) Int. Cl. H05B 47/195

(52) U.S. Cl. CPC H05B 47/195

(57) ABSTRACT

The present application provides an integrated intelligent dazzling LED lamp string controller, which is configured to control the display effect of the lamp string, and comprises a shell, a cover and a PCBA, wherein one end of the cover is an input terminal, the PCBA comprises a power supply area, a burning area and a core control area, and the burning area is configured to burn a firmware of a custom control program into a core control chip; the core control chip at least comprises a U3 and a peripheral component IR thereof, which is configured to receive an infrared signal emitted by an infrared remote controller, and a terminal pin of the U3 is connected with an antenna ANT.

### TECHNICAL FIELD

The present application belongs to the technical field of decorative lighting, in particular to a controller for an LED lamp string and a control system.

### BACKGROUND

In recent years, due to the advantages of energy saving and environmental protection, LED lamps have become the main trend in the development of lamp industry. LED lamps are widely used in traffic lights, large-area display screens, automobile signal lights, urban lighting projects, architectural decoration, Christmas and other festive lamp strings and other fields. The wide application of LED puts forward more requirements for its flashing method and control method. For example, all kinds of holiday lamp strings need more flashing scenes to increase the atmosphere and attraction. However, at present, most of the traditional lamp string control systems in the market are the combination of a controller and a power adapter, which are connected by a power extension cord, so there is the possibility of failure. In the traditional flashing mode of lamp strings, many single-color lamp strings flash synchronously, either in a fixed mode or randomly flashing in three colors of red, green and blue. There is no way to display complex flashing patterns, and the controller controls in a single way, generally only by infrared remote control and key control, and general controllers need a matching power adapter to supply power to LED lamp strings and controllers at the same time.

Therefore, it is necessary to invent an integrated intelligent dazzling controller for an LED lamp string.

### SUMMARY

The present application aims to provide a controller for an LED lamp string to solve the problems in the background technology.

In order to achieve the above purpose, the present application provides the following technical solution: the present application provides a controller for an LED lamp string, and the controller is configured to control a display effect of the lamp string, and the controller comprises a shell, a cover buckled on a top of the shell and a PCBA installed in the shell, wherein the PCBA comprises a power supply area, a burning area and a core control area, and the core control area comprises a core control chip.

Further, the core control chip includes a third IC chip U3 and a peripheral infrared receiver IR thereof, wherein the infrared receiver IR is configured to receive an infrared signal emitted by an infrared remote controller, and a terminal pin of the third IC chip U3 is connected with an antenna.

Specifically, the controller further includes an input elastic sheet and a connection block, wherein the input elastic sheet and the output connection block are respectively configured to clamp an input terminal and an output terminal.

Further, the input elastic sheet includes two folded metal sheets, which are arranged on a metal frame and are configured to clamp a conductive pin of the input terminal; the output connection block is provided with a plurality of parallel channels for connecting with a conductive pin of the output terminal; one of the conductive pin of the input terminal and the conductive pin of the output terminal is sheet-shaped and the other is cylindrical.

Further, the PCBA further includes a core power supply area, which is configured to convert high-voltage alternating current into low-voltage direct current; the power supply area is electrically connected with the core power supply area, and the core power supply area is configured to reduce high-voltage power to low-voltage power required by the core control area and supplying power to the core control area; the burning area is configured to burn a custom control program firmware into the core control chip.

Further, the power supply area includes a buffer circuit and a π-type filter circuit; a fourth diode D4, a sixteenth resistor R16 and a fifteenth resistor R15 in the buffer circuit are connected in series, and the fifteenth resistor R15 is connected in parallel with a fifteenth capacitor C15 for absorbing a peak voltage; a twentieth capacitor C20, a twenty-first capacitor C21, and a twenty-ninth resistor R29 in the π-type filter circuit are connected in series with a first inductor L1, and the first inductor L1 is connected in parallel with a first resistor R1, so as to suppress the generation of electromagnetic interference EMI.

Further, a fifth IC chip U5, a sixth resistor R6 and a seventh resistor R7 in the core control area are connected in series, the infrared receiver IR is connected in series with a thirteenth capacitor C13, and a thirteenth resistor R13 and a ninth capacitor C9 are connected in series with a first switch S1.

Further, the PCBA further includes a music rhythm area, which comprises a nineteenth resistor R19, a twentieth resistor R20, a fifth resistor R5, a tenth resistor R10, an eleventh resistor R11, a third capacitor C3, a fourth capacitor C4, an eighth capacitor C8, a sixth transistor Q6 and a second diode D2, and is configured to amplify and convert an analog signal of microphone internal resistance change information into a digital signal to be transmitted to the core control chip.

Preferably, the shell is made of an infrared transparent material.

Further, the embodiment of the application further provides a lamp string, including a plurality of LED lamp beads, characterized in that a lampshade is arranged every N lamp beads, where N is an integer greater than or equal to 1, the lampshade is fixed above the lamp beads, and the lampshade comprises a partially or completely transparent bulb cover.

Further, the embodiment of the application further provides a lamp string control system, including the above controller and/or the above lamp string, and further including an APP, wherein the APP communicates wirelessly with the controller through Bluetooth and infrared connection, and/or remotely controls the lamp string through infrared.

The technical solution provided by the application has the beneficial effects that: (1) the lamp string provided by the present application comprises a plurality of LED lamps which are connected in parallel and all have address codes, and the controller can control each LED lamp one by one according to the address codes, so that the lamp string can be operated to show the required shape, and when one LED lamp fails, other LED lamps will not be affected; (2) the controller can be controlled by means of keys, an infrared remote controller and a mobile APP to make the lamp string show a combination effect of various pre-designed modes, such as a scene mode, a music rhythm mode, a dazzling dimming mode, a DIY mode, a timed scene mode and the like that are suitable for different scenes.

### BRIEF DESCRIPTION OF DRAWINGS

In order to explain the technical solution in the embodiment of the present application more clearly, the following will briefly introduce the drawings needed in the description of the embodiment. Obviously, the drawings in the following description are only some embodiments of the present application. For ordinary technicians in this field, other drawings can be obtained according to these drawings on the premise of no creative labor.

FIG. 1 is an assembly schematic diagram of the controller in the present application;

FIG. 2 is a schematic diagram of the explosion structure of the controller in the present application;

FIG. 3 is a structural schematic diagram of the PCBA in the present application;

FIG. 4 is a structural schematic diagram of the input terminal of the present application;

FIG. 5 is a structural schematic diagram of the output terminal of the present application;

FIG. 6 is a circuit diagram of the PCBA in the present application;

FIGS. 7A and 7B are gain data structure diagrams of 32 bits data and 20 bits data of LED lamp strings in this application;

FIG. 8 is a schematic structural diagram of the guide code and data code in the present application;

FIG. 9 is the functional schematic diagram of the mobile phone APP, the controller and the lamp string in the present application;

FIG. 10 is a schematic structural diagram of lamp string connection in the embodiment of the present application;

FIG. 11 is a structural schematic diagram of a single decorative lamp of the present application;

FIG. 12 is a schematic structural diagram of the lampshade cover in an embodiment of the present application;

FIG. 13 is a front view of the lampshade cover in an embodiment of the present application;

FIG. 14 is a schematic structural diagram of the sleeve in an embodiment of the present application;

FIG. 15 is a schematic sectional view of the sleeve in an embodiment of the present application.

### REFERENCE NUMBERS

1—Shell; 11—PCBA; 111—Power supply area; 112—Burning area; 113—Core power supply area; 114—Musical rhythm area; 115—Core control area; 12—Input terminal; 121—Input terminal conductive pin; 122—Input elastic sheet; 13—Output terminal; 131—Output terminal conductive pin; 132—Output connection block; 2—Cover; 31—Lampshade cover; 311—Cover body; 312—Clamping block; 313—Lamp body positioning block; 314—Decorative hook; 32—Sleeve; 321—Connection block; 4—Lamp cord; 5—Lamp body; 6—Lampshade; 7—External thread; 8—Bulb.

### DESCRIPTION OF EMBODIMENTS

In order to make the purpose, technical solution and beneficial effects of the embodiment of the present application clearer, the technical solution in the embodiment of the present application will be clearly and completely described below with reference to the drawings in the embodiment of the present application. Obviously, the described embodiment is a part of the embodiment of the present application, but not the whole embodiment.

The following is an introduction and explanation of the terms involved in this application:

Address code: the address code of the lamp bead in a LED lamp usually needs to be burned by a burner or other burning systems. For example, in this application, the address code is burned into the burning area. Each lamp bead has its own address code, through which different lamp beads can be distinguished, and the address code is just like the identity number of the lamp bead. Therefore, by connecting a plurality of LED lamps in parallel, the controller can control each LED lamp separately.

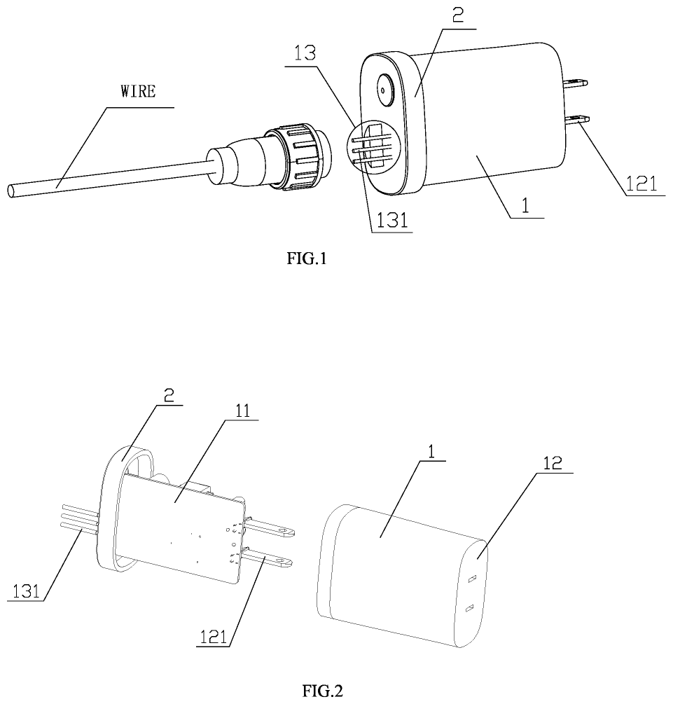

Referring to FIG. 1, FIG. 2 and FIG. 3, the present application provides a plug-in LED lamp string controller, which includes a shell 1, a cover 2 buckled on the shell 1, and a PCBA 11 (a printed circuit board plug-in assembly, that is, a finished circuit board). The PCBA 11 is installed in the shell 1, and is configured to connect the input terminal and the output terminal in series, so as to electrically control the lamp string. Wherein, the shell 1 is generally cuboid, and the edges of the cuboid shell 1 are all provided with rounded corners, and the cover 2 is fitted on the shell 1.

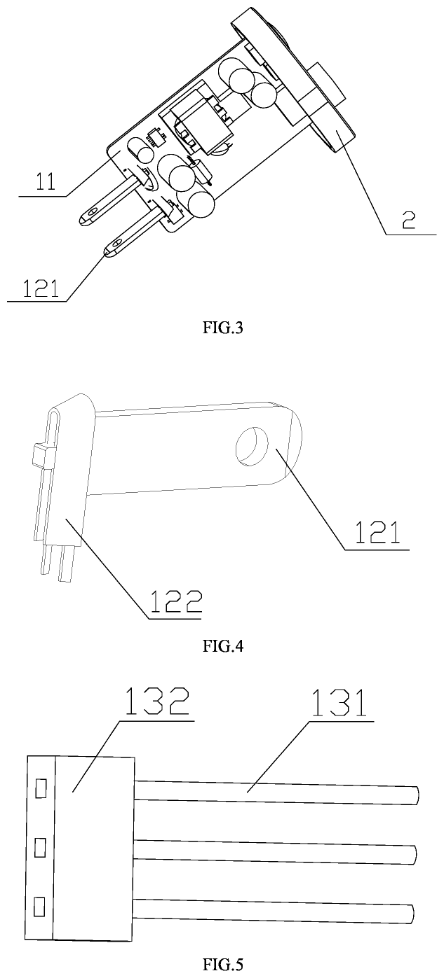

Specifically, the upper end of the PCBA 11 is movably connected with an input terminal conductive pin 121 through an input elastic sheet 122, and the input terminal conductive pin 121 penetrates out of the bottom of the shell 1 and extends outward for a certain length, so as to plug into the socket, thereby achieving the purpose of supplying power to the lamp string controller. Referring to FIG. 4, preferably, the number of input elastic sheets 122 is two, and in other embodiments, it may be three. Wherein, the conductive pin 121 at the input terminal is a conductive metal strip with a certain thickness, specifically, it is a combination of a rectangular cross-section and a semicircular cross-section, and a through hole is also provided at one end far away from the shell 1. The input elastic sheet is clamped between two folded metal sheets, the two folded metal sheets are arranged on the metal frame, and can be processed from a whole metal sheet, and the two folded metal sheets are used for clamping the conductive pin at the input terminal. One of the input terminal conductive pin and the output terminal conductive pin is sheet-shaped and the other is cylindrical.

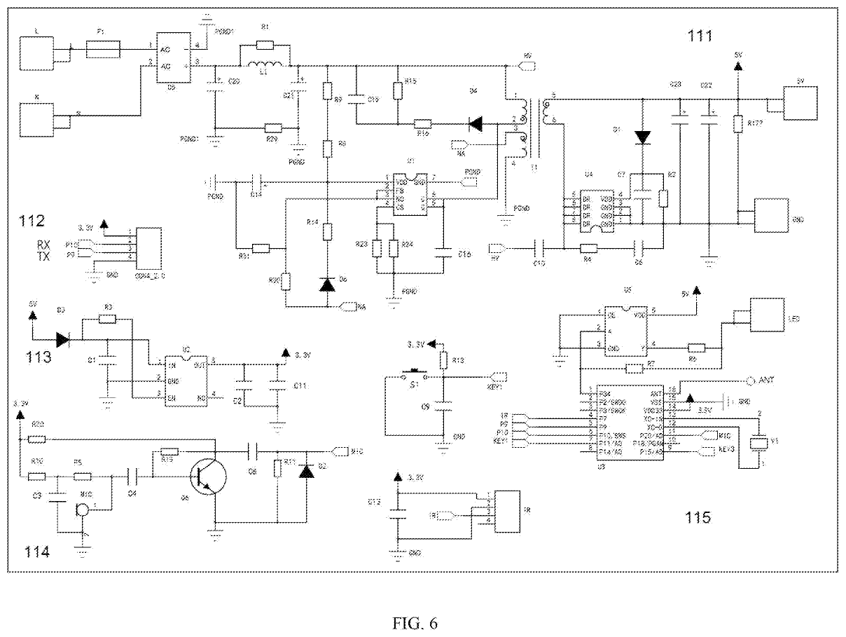

Specifically, referring to FIGS. 1 and 2, a signal line is clamped through an output connection block 132 (FIG. 5) or elastically connected with an output terminal conductive pin 131. The output terminal conductive pin 131 penetrates through the cover 2 and extends outward. One side of the cover 2 is the output terminal 13, which includes a semicircular positioning block and the output terminal conductive pin 131. The semicircular positioning block is configured to position and connect with a lamp bead connector, and the other side of the cover 2 is provided with a control button. The output terminal conductive pin 131 is generally cylindrical, and its outer end face is cambered. Preferably, the number of the conductive pins 131 at the output terminal is three, so as to avoid the problem of difficult winding due to the narrow internal space of the shell 1, thereby providing convenience for processing and manufacturing.

Specifically, the PCBA 11 is provided with a waterproof connector. Preferably, the waterproof connector adopts a 3PIN waterproof connector, and the 3PIN waterproof connector is configured to connect a power line, a bottom line and a signal line, wherein the power line and the bottom line are used for supplying power to the lamp string, and the signal line is configured to output control signals to the LED lamp. Wherein, there are a plurality of LED lamps on the lamp string, and the LED lamps are connected in parallel with each other, and the signal lines of the lamp beads are also connected in parallel with the bus, so that the LED lamps do not interfere with each other, that is, when one LED lamp fails, other LED lamps can work normally.

Specifically, on the PCBA 11, each LED lamp corresponds to an address code, and the controller can control each LED lamp through the address code, so that the LED lamps can display complex combined shapes or patterns, such as curtain lamps and Christmas tree lamps. The LEDs have built-in driver chips and lamp beads, while the outside is encapsulated by a fog colloid. Specifically, the lamp beads are divided into RGB three-color lamp beads and/or RGBW four-color lamp beads.

Wherein, the principle that the controller can operate the LED lamp to show the complex shapes or patterns is: the driver chip is connected by three wires, wherein the three wires are the above-mentioned power line, bottom line and signal line. After the driver chip is powered on and reset, that is, when the circuit is restored to the initial state, the signal pins of the driver chip include IO pins and PWM pins, which are used to receive the data information signals sent by the controller and analyze the data according to the preset related protocols. Specifically, RGB three-color lamp beads and/or RGBW four-color lamp beads are controlled by IO pins; the gray scales of R, G and B single-color lamp beads is controlled by PWM pins. Wherein, each single-color lamp bead has at least 256 gray levels, so LED lamps can mix 16,777,216(256³) colors through the gray levels of R, G and B single-color lamp beads, so the controller can control the appearance color, pattern or shape, the overall effect and the level of refreshing the time interval of the LED lamps according to the user's scene requirements, thus greatly improving the user's experience. Wherein, there are many kinds of scene effects, for example, a dazzling flowing water scene, a dazzling waterfall scene, a dazzling animation pattern scene, a dazzling text scene, etc. In order to quickly change the effect of the lamp string, it is preferable that the level of the time interval for refreshing the LED lamps is MS (millisecond).

In this embodiment, the controller can also divide the brightness of the LED lamp into 1000 levels, in other words, it can adjust 1000 kinds of brightness of the LED lamp. In a specific embodiment, referring to FIG. 6, the PCBA 11 includes a power adapter module and a lamp string controller module integrated on the same PCB (a printed circuit board), in which the power adapter is used to change the power supply, that is, to convert alternating current into direct current and output it, and the lamp string controller is used to adjust the effect of the lamp string. In FIG. 6, according to the working principle, PCBA 11 includes a power supply area 111, a burning area 112, a core power supply area 113, a music rhythm area 114 and a core control area 115. The power supply area 111 is used to convert alternating current into direct current and output it to the core power supply area 113. The core power supply area 113 is used to convert high voltage into low voltage and supply power to the core control area 115, which includes a core control chip. The burning area 112 is used to burn the custom control program firmware into the core control chip, and the core control chip communicates with the music rhythm area 114 by signal transmission. The lamp string controller of the present application can be connected with a mobile phone or an intelligent client through infrared or Bluetooth or other wireless transmission modes, and the mobile phone or the intelligent client can remotely control the controller according to the corresponding APP, specifically, it can control a lamp string group formed by a plurality of lamp strings to achieve different lighting and decoration effects, and can also form a rhythmic effect according to music.

Specifically, the power supply area 111 adopts isolated high-performance constant-current and constant-voltage primary-side control technology and synchronous rectification technology, and is used to convert high-voltage AC electric supply into low-voltage DC (5V). The power supply area 111 includes a first IC chip U1 and a fourth IC chip U4. The first IC chip U1 converts primary high-voltage electricity into safe low-voltage electricity (5V for human safety) through a Ti (an isolation transformer) and its peripheral components. Preferably, the switch of the first IC chip U1 adopts a high-performance constant current and constant voltage primary-side control power switch of KP2313, CSC7131, HP-08 or CSC7136.

In a specific embodiment, the power supply area 111 is provided with a buffer circuit for absorbing the peak voltage caused by the high-speed switch to ensure the safety and stability of the first IC chip U1. In particular, the fourth diode D4, the sixteenth resistor R16 and the fifteenth resistor R15 are connected in series, and the fifteenth resistor R15 is connected in parallel with the fifteenth capacitor. To prevent or suppress the circuit from generating electromagnetic interference (EWI; Electromagnetic Interference), and the power supply area 111 also provides a π-type filter circuit. The twentieth capacitor C20, the twenty-first capacitor C21 and the twenty-ninth resistor R29 are connected in series with the first inductor L1, and the first inductor L1 is connected in parallel with the first resistor R1. In order to improve the power efficiency (the power utilization rate of the controller), that is, the ratio of the input power to the output power of the uninterruptible power supply, the fourth IC chip U4 preferably adopts a synchronous rectification switch of JW7700 or KP4112.

In another specific embodiment, the power supply voltage output by the power supply area 111 is 5V, while the power supply voltage required by the core power supply area 113 is 3.3V. For this voltage conversion, referring to FIG. 6, the core power supply area 113 includes a low-noise, low dropout voltage conversion chip LDO (a low dropout regulator), and the voltage conversion chip LDO includes a voltage conversion circuit, wherein the second IC chip U2 is connected with a third diode D3 and a first capacitor C1, and the second IC chip U2 is also connected with a second capacitor C2 and an eleventh capacitor C11, so as to convert the 5V voltage of the power supply area 111 into 3.3V voltage for supplying power to the core control area.

In another specific embodiment, referring to FIG. 6, the third IC chip U3 of the core control chip is connected with the first crystal oscillator Y1, the fifth IC chip U5 is connected with the sixth resistor R6 and the seventh resistor R7, the thirteenth resistor R13 and the ninth capacitor C9 are connected in series with the first switch S1, and the infrared receiver IR is connected with the thirteenth capacitor C13.

Wherein, the core control chip adopts a ST17H66 Bluetooth BLE5.2 chip, wherein the ST17H66 Bluetooth BLE5.2 chip has the following features: (1) it is equipped with a 32-bit processor; (2) it supports the general multi-protocol SOC, Bletooth® LE 2 Mbps protocol; (3) it has 256 KB SPI NOR system flash memory; (4) it has 11 programmable GPIO pins; (5) it is provided with built-in 64 KB SRAM, and all data in the sleep mode is kept constant, the purpose of which is to burn the firmware of the custom control program into the core control chip through the burning area 112, so that the controller can be operated by pressing the button (S1) and/or the infrared remote controller and/or the mobile phone APP (named Hello Fairy) to realize the function adjustment of the lamp string.

Specifically, referring to FIG. 6, the first switch S1 can adjust the lighting effect by controlling the button, that is, lightly touching the button. The principle of adjusting the lighting effect by lightly touching the keys is that different times of pressing the key are preset by the firmware of the control program to correspond to different lighting effects, for example, pressing once is turned on, pressing twice continuously is the ticker mode, and pressing twice continuously switches the ticker to move the light slowly, thus changing the times of pressing the key to control the lighting string effect.

Specifically, the firmware of the control program includes an infrared signal receiving circuit, as shown in FIG. 6. The infrared signal receiving circuit includes an infrared receiver module (IR), a thirteenth capacitor C13 and GND, and the IR is used to receive the infrared signal emitted by the infrared remote controller. Specifically, the shell 1 is made of a special material through which infrared light can pass, so that infrared signal can pass through the shell 1, so that the IR can smoothly receive the control signal emitted by the infrared remote controller.

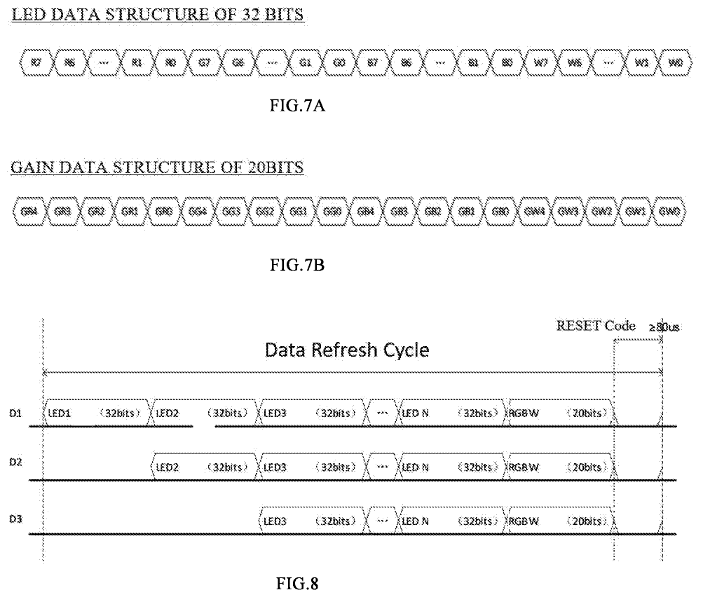

The control program receives the information sent by each key in the infrared remote controller to correspondingly realize the effect conversion of the lamp string. The infrared remote controller can also send software to decode key values through a NEC protocol (one of infrared remote control protocols), and realize corresponding control functions through preset key values, that is, pressing the key can remotely control the lamp string to realize different functions and show different effects, such as lamp string switching, color selection, brightness adjustment, timing, mode selection and sensitivity adjustment and so on.

Wherein, the infrared remote controller sends the key value decoded by NEC software, and the external receiver IR sends the value to the corresponding control area of the controller after receiving it. The controller sends the relevant lamp string control data according to the key value, so as to control each LED lamp respectively. During the control process, each lamp bead has its own address code, through which different lamp beads (just like their ID numbers) can be distinguished and controlled. Referring to FIG. 7A and FIG. 7B, the address code and the data code are inverted to enhance the correctness of the data. It should be noted that high-bit data are firstly transmitted for the LED data structure of 32 bits and the gain data structure of 20 bits, and data are sent in the order of RGBW. Specifically, FIG. 8 is the definition of the boot code and the data code. It should be noted that (1) when the default value of 12 mA current output is used, the controller can omit the gain of 20 bits RGBW; (2) D1 is the data sent by the controller, D2 and D3 are the data automatically shaped and forwarded by a cascade circuit.

Specifically, as shown in FIG. 6, the 16 terminal pins of the third IC chip 3 are connected with the antenna ANT, and are used to radiate radio frequency signals and connect to the mobile phone APP (Hello Fairy) through Bluetooth, so that the user can adjust the controller through the mobile phone APP Hello Fairy, thereby adjusting the effect of the lamp string through preset control instructions.

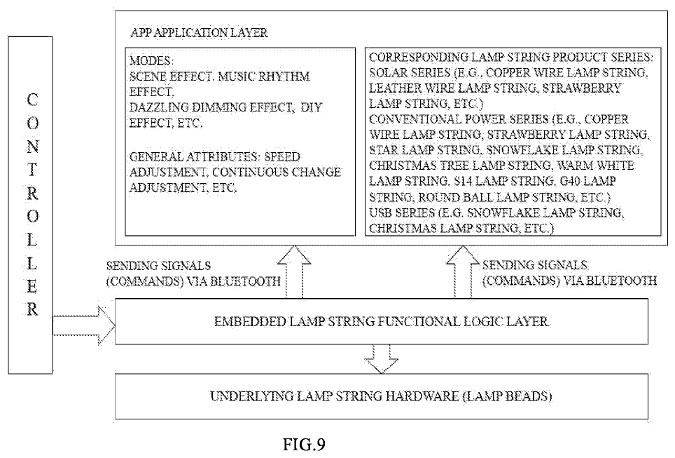

As shown in FIG. 9, mobile APP (Hello Fairy) includes a scene effect function, a music rhythm function, a dazzling dimming function, a timing/countdown function, a DIY function and a language control function. The APP can realize a variety of music rhythm modes, and the lamp string effect changes alternately with the changes of surrounding sounds (including music); the APP also supports 16 million kinds of color dimming. Specifically, there are 160,000 color dials on the APP, in which various points on the color dial correspond to different colors in the firmware of the custom control program, and users can call out various colors on the color dial; the APP also has a DIY function, which can meet the personalized customization needs of users; the APP has the function of timing/countdown, which is convenient for timing the switch, thus freeing hands; the APP also supports language control. Specifically, the APP supports Alexa voice control in order to improve the convenience of users.

In another embodiment, the core control area 115 is electrically connected with the music rhythm area 114, and the music rhythm area 114 includes a main control chip, which includes a microphone (MIC, for short) and its peripheral components, i.e., the nineteenth resistor R19, the twentieth resistor R20, the fifth resistor R5, the tenth resistor R10, the eleventh resistor R11, the third capacitor C3, the fourth capacitor C4, the eighth capacitor C8, the sixth electrode tube Q6 and the second diode D2. Wherein, the microphone can change its internal resistance according to the sound level of the collected sound, and the peripheral components amplify and convert the analog signal of the internal resistance change of the microphone into a digital signal to be transmitted to the custom control program firmware.

Specifically, the microphone can detect the sound level and frequency information of the surrounding environment, classify it according to the sound information, and change its internal resistance accordingly.

Specifically, the music mode includes at least an energy mode, a rhythm mode, a spectrum mode and a scroll mode. When the sound level change is detected, the lamp string is lit with seven colors of red, orange, yellow, green, cyan, blue, purple and starts to circulate, and the energy mode can change the brightness of the lamp string according to the sound level; in the absence of sound, the lamp string goes out; when the sound level change is detected, the lamp string is lit with seven colors of red, orange, yellow, green, cyan, blue, purple and moves to the right for circulation, and the rhythm mode can change the brightness of the lamp string according to the sound level; in the absence of sound, the lamp string automatically changes into a single-color breathing state; when the change of sound level is detected, the lamp string is lit from the middle to two sides with seven colors of red, orange, yellow, green, cyan, blue and purple. The spectrum mode can control the number of LED lamps lit according to the sound level to achieve the effect similar to the spectrum. Each three LED lamps are set as a group, and the brightness decreases in turn; when the change of sound level is detected, the color of each LED lamp is changed and moved to the previous LED lamp to achieve the scrolling effect.

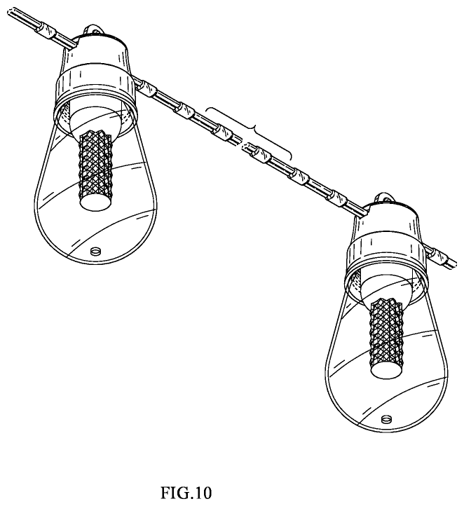

The lamp string provided by the present application can also be provided with a decorative lampshade outside each lamp bead, as shown in FIG. 10, so as to enhance the decorative effect. Preferably, a lampshade is provided every one to six lamp beads.

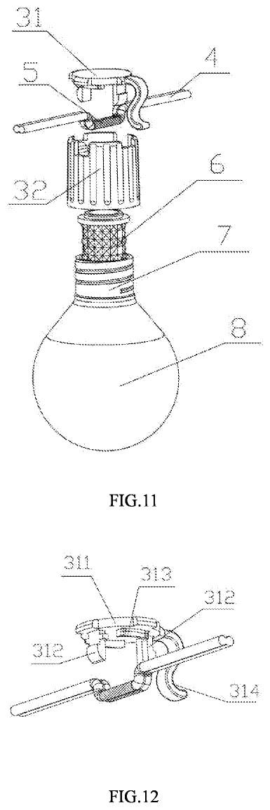

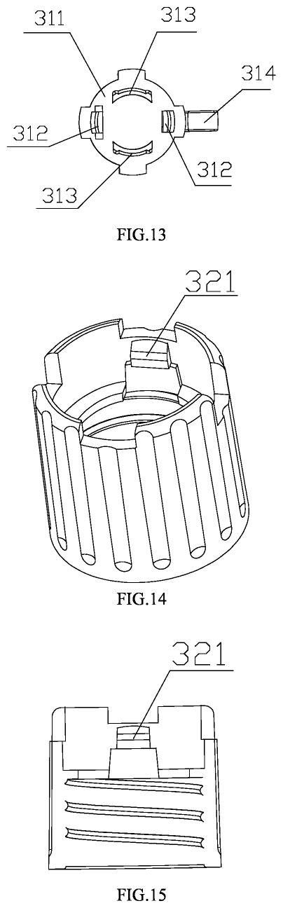

As shown in FIG. 11, the decorative lampshade includes a lampshade cover 31 and a sleeve 32. Specifically, as shown in FIGS. 12 and 13, the lampshade cover 31 includes a cover body 311, a clamping block 312, a lamp body positioning block 313 and a decorative hook 314. The cover body 311 is generally circular, and its circumference extends outward at equal intervals to form four bump structures. The inner surface of the cover body 311 is provided with the clamping block 312 and the lamp body positioning block 313. The number of the clamping blocks 312 and the lamp positioning blocks 313 are two respectively. Specifically, the connecting lines of two groups of opposite bump structures are cross lines, the clamping block 312 and the lamp body positioning block 313 are respectively arranged on one of the cross lines, and the decorative hook 314 is arranged on the bump structure surface where one clamping block 312 is located. The clamping block 312 has a generally arrow-shaped cross section, specifically, it is formed by connecting a section of rectangle with a right-angled trapezoid whose hypotenuse is a cambered surface, and the rectangle is connected with the longer bottom edge of the right-angled trapezoid for clamping with the connection block 321 (see FIG. 14) in the sleeve 32. The cross section of the lamp body positioning block 313 is bracket-shaped, and two lamp body positioning blocks 313 are oppositely arranged to form a slot, and the shape is similar to an arc bracket, so that the lamp body 5 (see FIG. 11) can be placed in the slot. The decorative hook 314 is generally S-shaped, and its edges are chamfered to increase safety.

Furthermore, the outer surface of the bump structure is provided with rounded corners, which increases the safety of the decorative lampshade.

Furthermore, the structures of the two clamping blocks 312 are slightly different, and the clamping block 312, which is far away from the decorative hook 314, has a lateral protrusion in the rectangular part.

As shown in FIGS. 14 and 15, the sleeve 32 has a hollow cylindrical structure, the outer surface of which is provided with anti-skid stripes, and the inner surface is divided into two parts: the upper part of the sleeve and the lower part of the sleeve, separated by a rib structure. The upper part of the sleeve is provided with two connection blocks 321, and the lower part of the sleeve is provided with internal threads for connecting with the external threads 7 of the upper part of the bulb 8 (see FIG. 11). Specifically, the top edge of the upper part of the sleeve is provided with four rectangular grooves, the positions of which correspond to the four bump structures of the lampshade cover body 311, so that the bump structures can be combined with the rectangular grooves. The four rectangular grooves are divided into A and B groups, and the connection block 321 (located on the inner surface of the sleeve) is arranged directly below the A group. The depth of the rectangular grooves in the A group is lower than that of the B group, and the depths of the grooves in the A and B groups are not greater than the upper part of the sleeve. By arranging the grooves in the B group, the grooves can accommodate the lamp cord 4 (see FIG. 11), and after being put in, it is pressed and fixed by the bump structure. The cross-sectional shape of the connection block 321 is the same as that of the clamping block 312, and the installation direction is opposite. Specifically, when the decorative sleeve is installed, the arrow direction of the clamping block 312 is downward, while the arrow direction of the connection block 321 on the sleeve 32 is upward. When the long sides of the right-angled trapezoid of the two blocks are attached to each other, the clamping installation is completed.

Lamp body installation process: as shown in FIG. 11, the lamp cord 4 and the lamp body 5 are pressed into the group B groove of the sleeve 32, and then the lampshade cover 31 is installed on the sleeve 32. Specifically, the bump structure of the lampshade cover 31 is aligned with the corresponding rectangular groove of the sleeve 32 and pressed down. When the long sides of the right-angled trapezoid of the clamping block 312 and the connection block 321 are attached to each other, the clamping installation is completed. Then, the lampshade 6 (to make the light emitted by the lamp body softer) is put into the bulb 8, and the bulb 8 is screwed into the sleeve from the lower part of the sleeve through the external thread 7 on the upper part of the bulb to complete the installation. When the lampshade cover 31 and the sleeve 32 need to be disassembled, the clamping block 312 can be separated from the connection block 321 by pressing the curved surface of the clamping block 312 with a hard object, and the disassembly can be completed. Specifically, the bulb 8 can be made of a partially or completely transparent material, and being partially transparent is not translucent, but part, such as the lower half, is completely transparent.

The integrated lamp string controller provided by the present application has simple structure and high integration, which solves the problems of complex composition and low connection reliability of the existing lamp string system. Specifically, the lamp string unit can be a copper wire lamp.

The present application provides a three-line dazzling point-controlled lamp string controller, which can realize the control of the point-controlled RGB lamp beads, realize the independent control of all the lamp beads of the lamp string at the same time, and light up different colors, with up to 160,000 colors, to realize various dazzling flashing modes, and can customize the lighting flashing mode and timing switch functions at will. It solves the problems of single color, fixed flashing mode, no self-defined flashing mode, fixed timing and no arbitrary adjustment of the traditional two-wire lamp string.

The present application provides a lamp string controller with multiple control modes. This controller has a Bluetooth APP control function, which can realize Bluetooth wireless control of the lamp string through an intelligent APP by using Bluetooth of a mobile phone.

The APP has rich functions, including a scene mode selection, a music rhythm mode selection, adjustable 160,000 colors, a self-defined blinking scene, a timing setting, etc. The scene mode is displayed by animation, therefore what you see is what you get. The APP scene animation corresponds to the actual flashing pattern of the lamp string, so that users can conveniently choose their favorite scene. It can also be controlled by infrared remote controller, and a 24-key or 40-key wireless infrared remote controller can quickly realize the functions of 20 scenes mode selections, 16 single-color mode selections, 4 music mode selections, brightness level adjustment, lamp string switching, timing and so on. Through local key control, it can realize the functions of 20 scene modes, 16 single-color modes, 4 music modes, and lamp string switching. A high-sensitivity microphone is integrated in the controller. In the music rhythm mode, the flashing control of the lamp string can be realized by monitoring the external sound level and the sound energy, and the flashing color and mode can be customized. It solves the problems of the traditional lamp string of less control modes, lack of intelligent control mode and lack of self-defined control modes.

The above is only the preferred embodiment of the present application, and does not restrict the present application in any form. Although the present application has been disclosed in the preferred embodiment, it is not intended to restrict the present application. Any brief introduction modification, equivalent change and modification made by a person skilled in the art according to the technical essence of the present application without departing from the scope of the technical solution of the present application still belongs to the scope of the technical solution of the present application.

What is claimed is:

1. A controller for an LED lamp string, wherein the controller is configured to control a display effect of the lamp string, and the controller comprises a shell, a cover buckled on a top of the shell and a PCBA installed in the shell, wherein the PCBA comprises a power supply area, a burning area and a core control area, and the core control area comprises a core control chip.

2. The controller of claim 1, wherein the core control chip comprises a third IC chip U3 and a peripheral infrared receiver IR thereof, wherein the infrared receiver IR is configured to receive an infrared signal emitted by an infrared remote controller, and a terminal pin of the third IC chip U3 is connected with an antenna.

3. The controller of claim 1, wherein the controller further comprises an input elastic sheet and a connection block, wherein the input elastic sheet and the output connection block are respectively configured to clamp an input terminal and an output terminal.

4. The controller of claim 3, wherein the input elastic sheet comprises two folded metal sheets which are arranged on a metal frame and are configured to clamp an input terminal conductive pin; the output connection block is provided with a plurality of parallel channels for connecting with an output terminal conductive pin; one of the input terminal conductive pins and the output terminal conductive pin is sheet-shaped and the other is cylindrical.

5. The controller of claim 1, wherein the PCBA further comprises a core power supply area which is configured to convert high-voltage alternating current into low-voltage direct current; the power supply area is electrically connected with the core power supply area, and the core power supply area is configured to reduce high-voltage power to low-voltage power required by the core control area and supplying power to the core control area; and the burning area is configured to burn a custom control program firmware into the core control chip.

6. The controller of claim 1, wherein the power supply area comprises a buffer circuit and a π-type filter circuit;
a fourth diode D4, a sixteenth resistor R16 and a fifteenth resistor R15 in the buffer circuit are connected in series, and the fifteenth resistor R15 is connected in parallel with a fifteenth capacitor C15 for absorbing a peak voltage;
a twentieth capacitor C20, a twenty-first capacitor C21, and a twenty-ninth resistor R29 in the π-type filter circuit are connected in series with a first inductor L1, and the first inductor L1 is connected in parallel with a first resistor R1, so as to suppress the generation of electromagnetic interference EMI.

7. The controller of claim 1, wherein a fifth IC chip U5, a sixth resistor R6 and a seventh resistor R7 in the core control area are connected in series, the infrared receiver IR is connected in series with a thirteenth capacitor C13, and a thirteenth resistor R13 and a ninth capacitor C9 are connected in series with a first switch S1.

8. The controller of claim 1, wherein the PCBA further comprises a music rhythm area, which comprises a nineteenth resistor R19, a twentieth resistor R20, a fifth resistor R5, a tenth resistor R10, an eleventh resistor R11, a third capacitor C3, a fourth capacitor C4, an eighth capacitor C8, a sixth transistor Q6 and a second diode D2, and is configured to amplify and convert an analog signal of microphone internal resistance change information into a digital signal to be transmitted to the core control chip.

9. The controller of claim 1, wherein the shell is made of an infrared transparent material.

10. A lamp string comprising a plurality of LED lamp beads, wherein a lampshade is arranged every N lamp beads, where N is an integer greater than or equal to 1, the lampshade is fixed above the lamp beads, and the lampshade comprises a partially or completely transparent bulb cover.

11. A lamp string control system comprising the controller of claim 1, and further comprising an APP, wherein the APP communicates wirelessly with the controller through Bluetooth and infrared connection, and/or remotely controls the lamp string through infrared.

12. A lamp string control system comprising the lamp string of claim 10, and further comprising an APP, wherein the APP communicates wirelessly with the controller through Bluetooth and infrared connection, and/or remotely controls the lamp string through infrared.
